(19) United States
(12) Patent Application Publication
(10) Pub. No.: US 2026/0125132 A1
(43) Pub. Date: May 7, 2026

(54) All-Terrain Vehicle

(71) Applicant: Zhejiang CFMOTO Power Co., Ltd., Hangzhou (CN)

(72) Inventors: Xiadong Chen, Hangzhou (CN); Wenbing Duan, Hangzhou (CN); Chen Yang, Hangzhou (CN); Jiangang Wang, Hangzhou (CN); Chunling Li, Hangzhou (CN); Liming Liu, Hangzhou (CN)

(21) Appl. No.: 19/434,573

(22) Filed: Dec. 29, 2025

Related U.S. Application Data
(63) Continuation of application No. PCT/CN2024/102714, filed on Jun. 28, 2024.

(30) Foreign Application Priority Data
Jun. 30, 2023 (CN) 202310801973.4

(51) Int. Cl. B62K 5/01; F02B 29/04; F16H 3/093; F16H 63/34

(52) U.S. Cl. CPC B62K 5/01; F02B 29/0443; F16H 3/093; F16H 63/3425

(57) ABSTRACT

An all-terrain vehicle has a prime mover assembly which includes a tall and narrow gearbox. The collection of shafts in the gearbox include a (highest) input shaft, a (lowest) front output shaft, and a (forwardmost) reverse shaft, as well as a (rearwardmost) rear output gear. A shaft spacing aspect ratio of the vertical shaft spacing distance to the horizontal shaft spacing distance is greater than or equal to 0.85 and less than or equal to 1.4. A parking pawl control linkage has a pawl control wheel, with a park lobe, rotationally mounted about an axis of the shifting shaft used for gear shifting. Rotation of the shifting shaft into park causes rotation of the pawl control wheel such that the park lobe pushes on the parking pawl to move the parking pawl from the disengaged position to the engaged position.

### RELATED APPLICATION INFORMATION

This application is a continuation of PCT/CN2024/102714, filed Jun. 28, 2024 and entitled “All-Terrain Vehicle”, and claims priority to Chinese patent application filed on Jun. 30, 2023, with an application number of 202310801973.4 and entitled “All-Terrain Vehicle”, the contents both of which are incorporated herein by reference in their entireties.

### FIELD OF THE DISCLOSURE

The present invention relates to the technical field of vehicles, in particular to an all-terrain vehicle.

### BACKGROUND OF THE DISCLOSURE

In related arts, as an outdoor vehicle, an all-terrain vehicle needs to adapt to different scenarios and complex working conditions, and poses higher power requirements on an engine of the all-terrain vehicle. In addition, in order to cope with various scenarios, the all-terrain vehicle needs to switch frequently between different gears to adapt to the current road conditions. Long-term operation of the gear-shifting mechanism is likely to cause driver fatigue. How to provide an electronic gear-shifting structure with simple, convenient operation and high reliability remains an urgent problem to be solved for those skilled in the art.

### SUMMARY OF THE INVENTION

Embodiments of the present invention provide an all-terrain vehicle to solve at least one problem existing in the background art.

In a first aspect, the present invention involves an all-terrain vehicle having a frame, a body cover at least partially arranged on the frame and four wheels supporting the frame. A prime mover assembly is supported on the frame and configured to drive the wheels to rotate for locomotion of the all-terrain vehicle. A gearbox configured to output torque of the prime mover assembly is at least partially arranged on the prime mover assembly. The gearbox has a collection of shafts supported within a gearbox housing, including at least an input shaft, a reverse shaft and a front output shaft. Each of the collection of shafts rotate about an axis which extends generally horizontally and transverse relative to the frame of the all-terrain vehicle. The input shaft is elevationally highest in the collection of shafts. The front output shaft is elevationally lowest in the collection of shafts. A vertical shaft spacing distance is defined between an axis of the input shaft and an axis of the front output shaft. The reverse shaft is forwardmost in the collection of shafts. The gearbox also includes a rear output gear supported within the gearbox housing for rotation about a rear output gear axis which extends generally horizontally and transverse relative to the frame of the all-terrain vehicle. The rear output gear axis is further rearward than the axis of the input shaft and further rearward than the axis of the front output shaft. A horizontal shaft spacing distance is defined between an axis of the reverse shaft and the rear output gear axis. A shaft spacing aspect ratio of the vertical shaft spacing distance to the horizontal shaft spacing distance is greater than or equal to 0.85 and less than or equal to 1.4.

In another aspect, the gearbox also has a shifting drum on a shifting shaft within the gearbox housing. The shifting drum has at least one shifting contour on its periphery. A shifting actuator can be controlled to drive the shifting shaft to rotate, and the shifting shaft drives the shifting drum to rotate to realize gear shifting of at least one gear on the collection of shafts via the shifting contour. A parking gear supported on one of the collection of shafts within the gearbox housing. A parking pawl is supported within the gearbox housing. The parking pawl has a disengaged position relative to the parking gear that allows the parking gear and at least the front output shaft and the rear output gear to rotate. That the parking pawl has an engaged position relative to the parking gear that prevents the parking gear and at least the front output shaft and the rear output gear from rotating. The parking pawl is moved using a parking pawl control linkage. The parking pawl control linkage has a pawl control wheel rotationally mounted about an axis of the shifting shaft. The pawl control wheel has a park lobe. Rotation of the shifting shaft causes rotation of the pawl control wheel such that the park lobe pushes on the parking pawl to move the parking pawl from the disengaged position to the engaged position.

Details of one or more embodiments of the present invention are provided in the following drawings and descriptions, such that other features, purposes and advantages of the present invention are more concise and understandable.

### BRIEF DESCRIPTION OF THE DRAWINGS

FIG. 1 is a front left perspective view of an all-terrain vehicle (“ATV”) of the present invention;

FIG. 2 is a front left perspective view of a prime mover assembly of the present invention for use in the ATV of FIG. 1;

FIG. 3 is a front left perspective view of the prime mover assembly of FIG. 2, without showing the air intake and exhaust systems, and showing only the inner cover of the continuously variable transmission (“CVT”) in exploded view

FIG. 4 is a front left exploded view of the engine in the prime mover assembly of FIGS. 2 and 3;

FIG. 5 is a front left perspective view of the gearbox in the prime mover assembly of FIGS. 2 and 3;

FIG. 6 is a front left perspective view of the gearbox of FIG. 5, showing the input shaft cover in exploded view;

FIG. 7 is a front right perspective view of the gearbox and exploded view input shaft cover of FIG. 6;

FIG. 8 is a left side view of the gearbox of FIGS. 5-7 with the input shaft cover and the output shaft cover removed;

FIG. 9 is a rear right perspective view of the gearbox of FIGS. 5-8 with the gearbox housing, other than the input shaft cover and front delivery shaft sleeve, removed;

FIG. 10 a left side view of the gearbox of FIGS. 5-9 with the entire gearbox housing removed;

FIG. 11 is a cross-sectional view of the gearbox of FIGS. 5-7 taken through the axis of the countershaft;

FIG. 12 is a right side view of the parking pawl on the shifting shaft and the parking gear of FIG. 9 as used in the gearbox of FIGS. 5-11, showing the parking pawl in an engaged (park) position;

FIG. 13 is a right side view of the parking pawl on the shifting shaft and the parking gear of FIGS. 9 and 12, showing the parking pawl in a disengaged (such as forward);

FIG. 14 is a rear left perspective view of the parking pawl control linkage of FIG. 9 on the shifting shaft used in the gear shifter of the gearbox of FIGS. 5-11;

FIG. 15 is a rear left exploded view of the parking pawl control linkage of FIGS. 9 and 14;

FIG. 16 is a rear right exploded view of the parking pawl control linkage of FIGS. 9, 14 and 15;

FIG. 17 is an inside perspective view of the gear position sensor used in the gearbox of FIGS. 5-11;

FIG. 18 is an exploded outer side view of the gear position sensor of FIG. 17;

FIG. 19 is a cross-sectional front view of the engine of FIGS. 2-4;

FIG. 20 is a front left perspective view of the internal lubrication structure of the engine of FIGS. 2-4 and 19;

FIG. 21 is rear left perspective view of the crankshaft and alternator of the engine of FIGS. 2-4 and 19;

FIG. 22 is a rear cross-sectional view of a portion of the crankshaft of FIG. 21;

FIG. 23 is a front perspective view of the cooling system of the engine of FIGS. 2-4 and 19, also showing part of the cylinder head cover of the engine of FIGS. 2-4 and 19 and the supercharger of FIG. 2;

FIG. 24 is a rear perspective view of the cooling system and cylinder head cover portion of FIG. 23, without showing the radiator or supercharger; and

FIG. 25 is a cross-sectional view of the supercharger coolant control connector of the cooling system of FIGS. 23 and 24.

### DETAILED DESCRIPTION

In order to enable those skilled in the art to better understand the solution of the present invention, the technical solutions in specific embodiments of the present invention will be clearly and completely described below in conjunction with the drawings in the embodiments of the present invention. It should be understood that for those skilled in the art, improvements or transformations can be made based on the above description, and all these improvements and transformations should fall within the protection scope of the appended claims of the present invention.

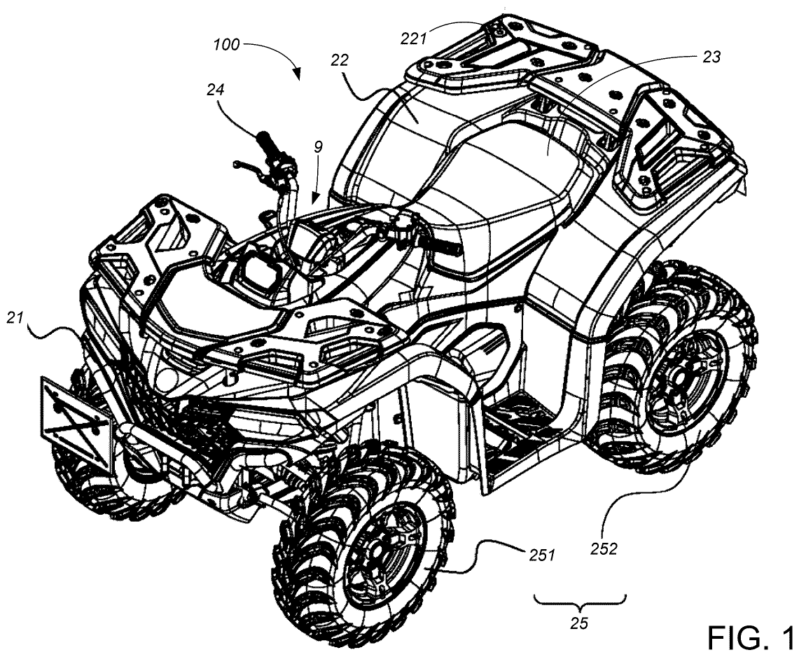

As shown in FIGS. 1 to 3, the present invention involves an all-terrain vehicle 100 (“ATV”) having an internal combustion engine 1 provided as part of a prime mover assembly 10. The ATV 100 includes a frame 21, a body cover 22 preferably including a rear cargo platform 221, a straddle seat 23, a steering system 24 and four wheels 25. The prime mover assembly 10 is at least partially arranged on the frame 21, and at least two and more preferably all four wheels 25 are in transmission connection with the prime mover assembly 10 through a drive train (not shown) providing torque such that the four wheels 25 provide locomotion for the ATV 100 to travel. The wheels 25 include two front wheels 251 and two rear wheels 252. The steering system 24 controls the steering orientation of the front wheels 251 so a driver can control the traveling direction of the ATV 100. The driver sits on the straddle seat 23 during operation of the ATV 100, and the engine 1 is preferably located under the straddle seat 23 and/or between the driver's legs.

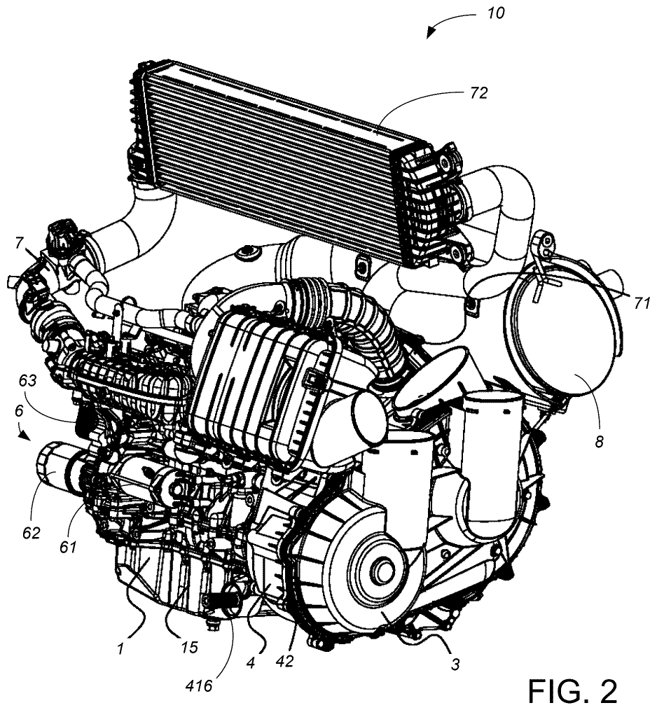

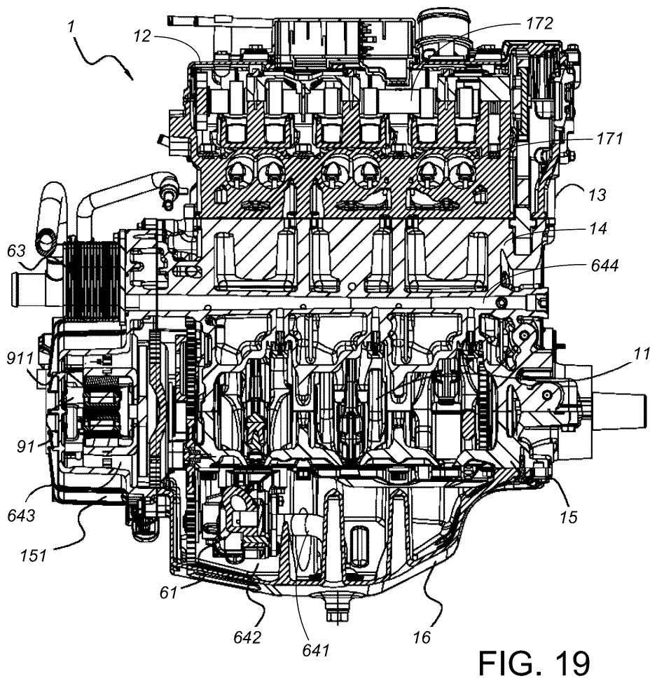

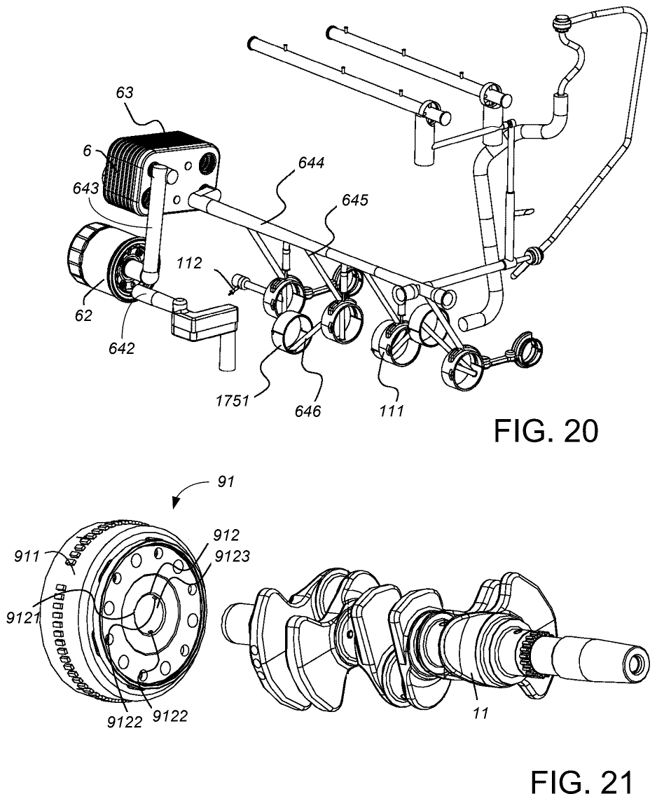

As shown in FIG. 2, in addition to the engine 1, the prime mover assembly 10 further includes a transmission 3 which is preferably a continuously variable transmission (“CVT”) and a gearbox 4. The CVT 3 is configured to transmit the torque of the engine 1 to the gearbox 4. The gearbox 4 transmits torque based on gear selection, such as forward, reverse, neutral, park, etc. A cooling system 5 (shown only in small part in FIG. 4, further shown in FIG. 23) is provided to help remove heat from the engine 1. A lubrication system 6 (shown only in part in FIG. 4, further shown in FIG. 20) is provided to lubricate moving parts of the engine 1. Returning to FIG. 2, an air intake system 7 provides combustion air to the engine 1 and preferably also cooling air for the CVT 3. An exhaust system 8 expels exhaust gas from the engine 1. The ATV 100 also includes an electrical system 9 generally called out in FIG. 1, which includes an alternator 91 (called out in FIG. 4, further shown in FIGS. 19 and 21) driven by the engine 1 to provide electricity to a battery (not shown) and various other electrical components of the ATV 100.

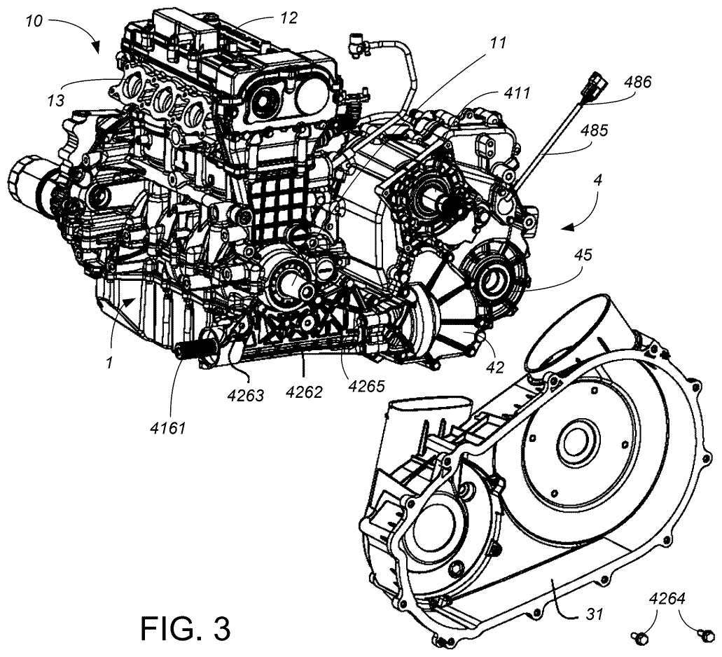

FIG. 3 shows the prime mover assembly 10 with the CVT 3 removed, showing an inside cover 31 of the CVT 3 in exploded view. The CVT 3 smoothly transmits torque from a crankshaft 11 of the engine 1 to an input shaft 411 of the gearbox 4.

The engine 1 is shown in exploded view in FIG. 4, separating generally stationary housing portions 12-16 from the generally moving and operational portions 17. Specifically, from top to bottom the engine 1 includes a cylinder head cover 12, a cylinder head 13, an engine block 14, a crankcase 15 and an oil pan 16. The cylinder head 13 is at least partially arranged between the cylinder head cover 12 and the engine block 14, connecting the cylinder head cover 12 to the engine block 14. The crankcase 15 is at least partially arranged between the engine block 14 and the oil pan 16, connecting the oil pan 16 to the engine block 14. An end of the crankshaft 11 extends laterally beyond the edges of the engine block 14 and crankcase 15 and through the inside cover 31 of the CVT 3, so the crankshaft 11 transmits torque directly to the interior components (not shown) of the CVT 3.

Like the crankshaft 11 extending laterally out of the engine 1 and as shown in FIG. 3, the input shaft 411 of the gearbox 4 extends laterally beyond the edge of a gearbox housing 42 and through the inside cover 31 of the CVT 3. The interior components of the CVT 3 transmit torque directly to the input shaft 411 of the gearbox 4. While the preferred embodiment has a CVT inside cover 31 which is separate from but fixed to the engine block 14, crankcase 15 and gearbox housing 42, the CVT inside cover 31 could alternatively be made integrally with the engine block 14, the crankcase 15 and/or the gearbox housing 42. Having the crankshaft 11 and the input shaft 411 of the gearbox 4 extend into the interior of the CVT 3 for direct torque transmission with the CVT 3 reduces the space occupied by the prime mover assembly 10 and reduces the number of components, such that the arrangement structure of the prime mover assembly 10 is compact, and space utilization rate and transmission efficiency are improved.

In the preferred embodiment depicted and as best shown in FIG. 4, the engine block 14 defines three cylinders 141. Valves 171 for each cylinder 141 are mounted in the cylinder head 13. The reciprocating position of each valve 171 is controlled by one or more preferably two cam shafts 172, to control introduction of air and expelling of exhaust gas from each cylinder 141. A fuel injector 173 is preferably also provided for each cylinder 141, to control introduction of fuel to each cylinder 141 mixed with air for combustion. A piston 174 moves reciprocally in each cylinder 141, with each piston 174 linked to the crankshaft 11 to cause rotation of the crankshaft 11. The lubrication system 6 includes an oil pump 61 driven by the crankshaft 11 as well as an oil filter 62 and an oil cooler 63.

The engine 1 is arranged transversely, that is, the crankshaft 11 extends basically along a left-right direction on the ATV 100. The preferred embodiment places the CVT 3 on the left end of the crankshaft 11 and the oil pump 61 and the alternator 91 on the right end of the crankshaft 11, but this left to right orientation can be easily reversed.

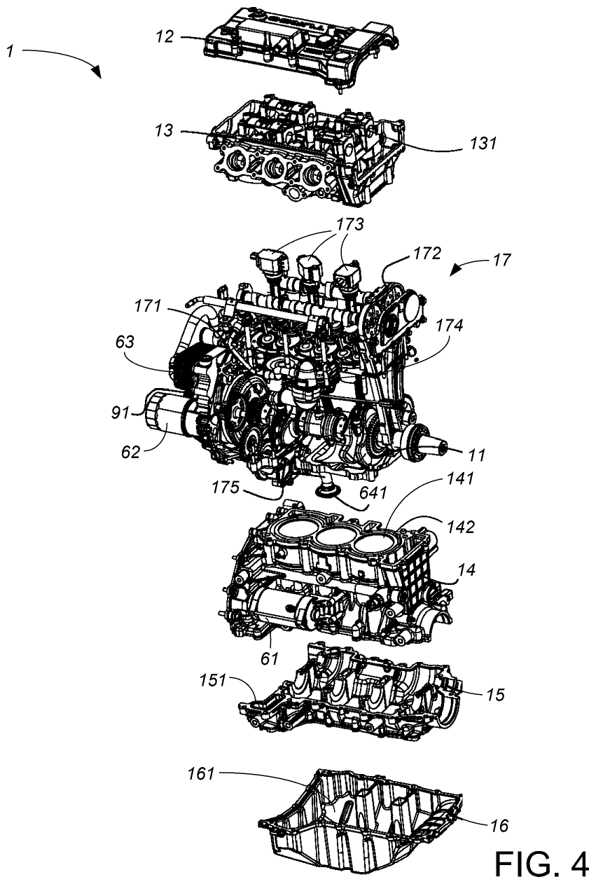

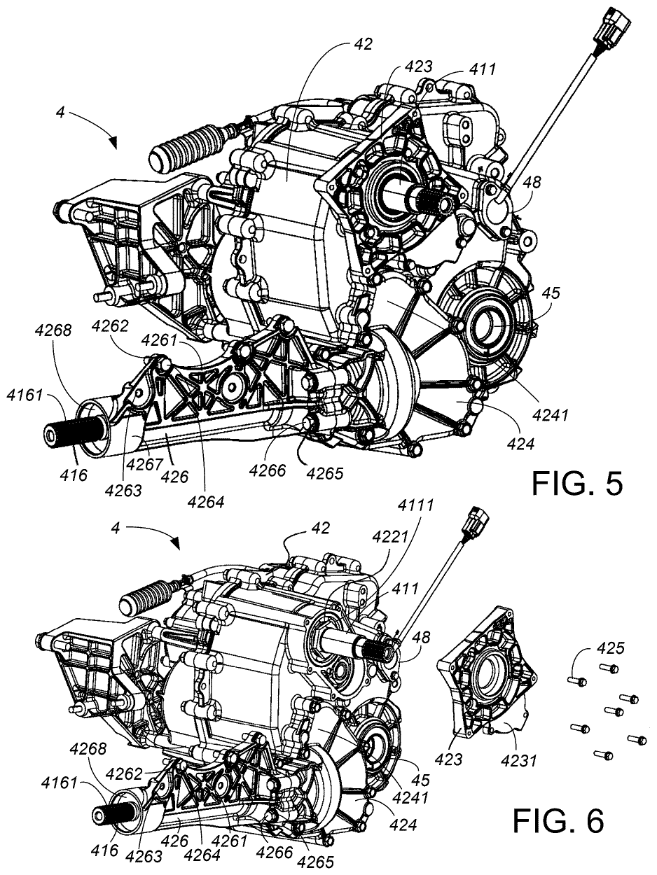

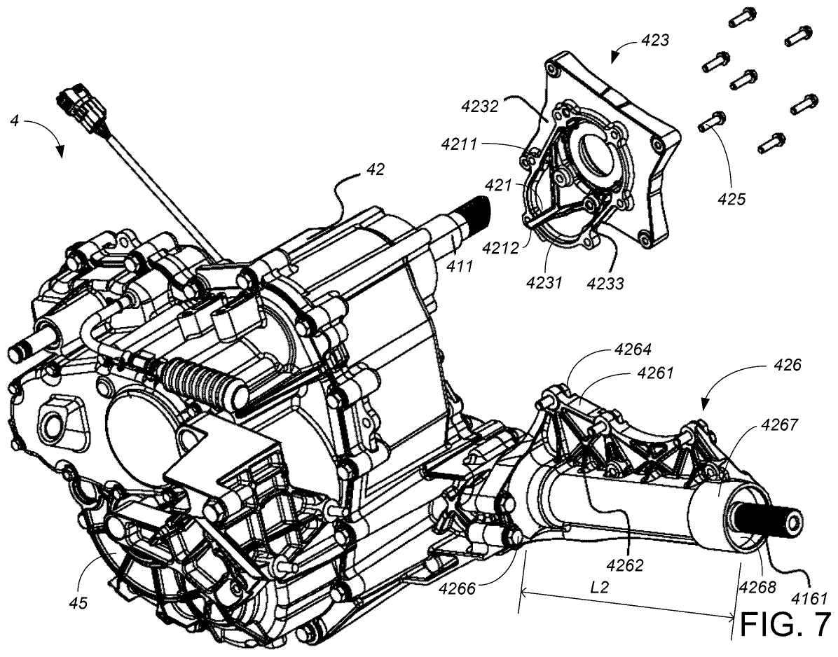

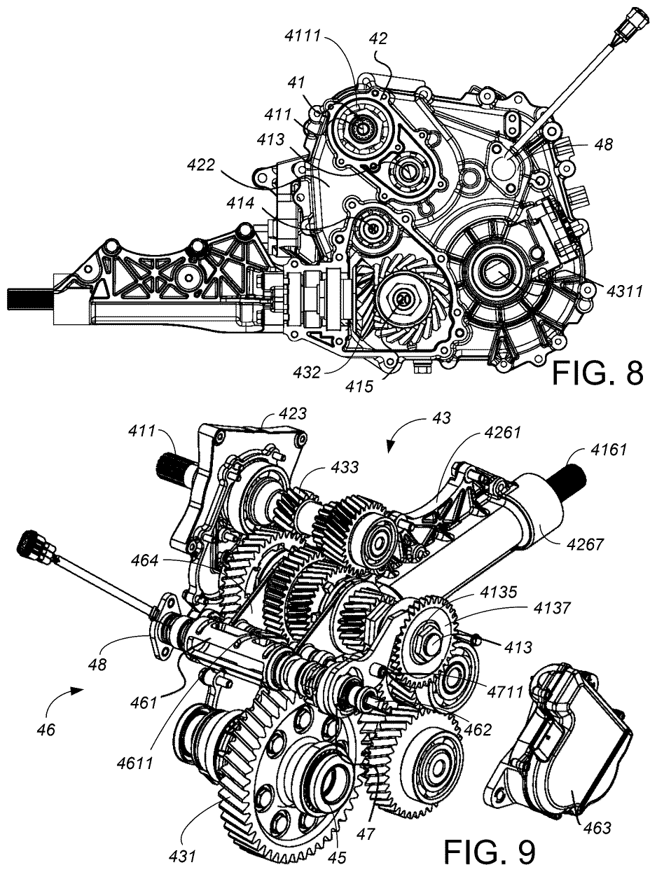

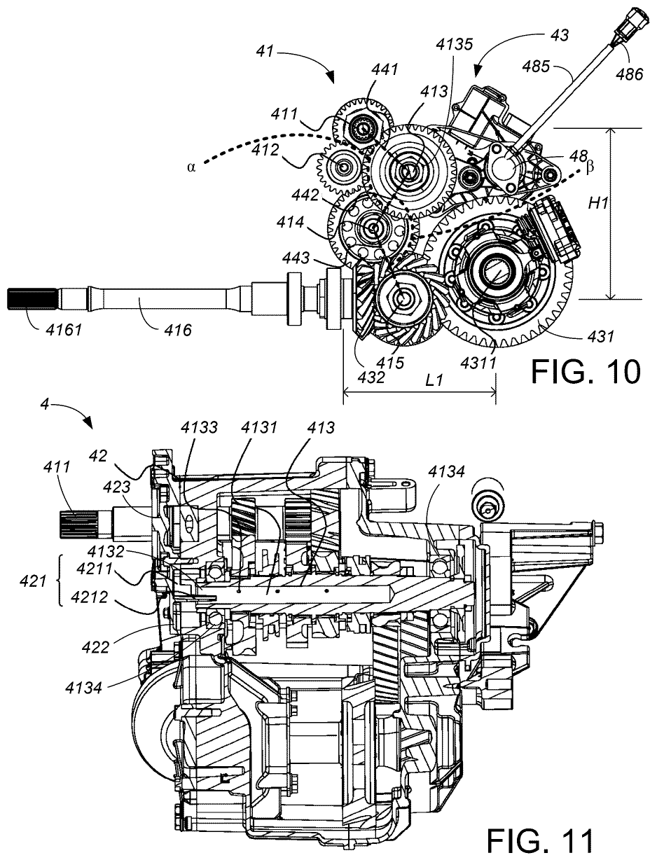

While the gearbox 4 is generally shown through FIGS. 5-10, the preferred layout of the gearbox 4 is best understood with reference to FIGS. 9 and 10. The preferred gearbox 4 makes full use of vertical space and minimizes the longitudinal length, with the preferred gearbox 4 being taller and narrower than traditional gearboxes. Specifically, the gearbox 4 has a number of shafts 41, which include the input shaft 411, a reverse shaft 412, a countershaft 413, an intermediate shaft 414, and a front output shaft 415 all rotating about transversely extending generally horizontal axes, as well as a front delivery shaft 416 extending forwardly and rotating about a longitudinally-extending generally horizontal axis. The gearbox 4 has a gear assembly 43 including a rear output gear 431 which rotates about a rear output gear axis 4311. Along a vertical direction of the gearbox 4, the reverse shaft 412, the countershaft 413 and the intermediate shaft 414 are all arranged between the input shaft 411 and the front output shaft 415 and are in transmission connection through the gear assembly 43. Along the vertical direction of the gearbox 4, the input shaft 411, the reverse shaft 412, the countershaft 413, the intermediate shaft 414, the rear output gear axis 4311 and the front output shaft 415 are distributed sequentially from top to bottom. Along a front-rear direction of the gearbox 4, the input shaft 411, the intermediate shaft 414, the countershaft 413 and the front output shaft 415 are all arranged between the reverse shaft 412 and the rear output gear axis 4311. In order to make full use of vertical space, the spacing between each shaft 411, 412, 413, 414, 415 along the vertical direction is relatively large. In order to reduce the space occupied by the gearbox 4 in the front-rear direction, the spacing occupied by the input shaft 411, the reverse shaft 412, the countershaft 413, the intermediate shaft 414, the front output shaft 415 and the rear output gear 431 along the front-rear direction is relatively small.

Specifically and as called out in FIG. 10, a vertical (heightwise on the ATV 100) shaft spacing distance H1 between the axis of the input shaft 411 and the axis of the front output shaft 415 is preferably greater than or equal to 170 mm and less than or equal to 230 mm, more preferably greater than or equal to 180 mm and less than or equal to 220 mm, even more preferably greater than or equal to 190 mm and less than or equal to 210 mm, and most preferably 200 mm. By having the vertical shaft spacing distance H1 within these ranges, vertical space of the gearbox 4 is well utilized, thereby making full use of the arrangement space of the ATV 100 in the vertical direction. A horizontal (lengthwise on the ATV 100) shaft spacing distance L1 between the axis of the reverse shaft 412 and the rear output gear axis 4311 is preferably greater than or equal to 160 mm and less than or equal to 200 mm, more preferably greater than or equal to 170 mm and less than or equal to 190 mm, and most preferably greater than or equal to 175 mm and less than or equal to 185 mm. By having the horizontal shaft spacing distance L1 within these ranges, the space occupied by the gearbox 4 in the front-rear direction is reduced, thereby leaving more arrangement space for other components of the ATV 100 in the longitudinal direction. A shaft spacing aspect ratio H1/L1 of the vertical shaft spacing distance H1 to the horizontal shaft spacing distance L1 is preferably greater than or equal to 0.85 and less than or equal to 1.4, more preferably greater than or equal to 1 and less than or equal to 1.35, and most preferably greater than or equal to 1.2 and less than or equal to 1.3. Through such an arrangement, the gearbox 4 makes full use of vertical space while reducing the use of longitudinal space, thereby providing a tall and narrow gearbox 4 with a compact structure.

As shown in FIG. 10, an input/counter connecting line 441 is defined between the axis of the input shaft 411 and the axis of the countershaft 413, a counter/intermediate connecting line 442 is defined between the axis of the countershaft 413 and the axis of the intermediate shaft 414, and an intermediate/front output line 443 is defined between the axis of the intermediate shaft 414 and the axis of the front output shaft 415. An upper gearing angle α between the input/counter connecting line 441 and the counter/intermediate connecting line 442 is preferably greater than or equal to 90° and less than or equal to 110°. A lower gearing angle β between the counter/intermediate connecting line 442 and the intermediate/front output connecting line 443 is preferably greater than or equal to 110° and less than or equal to 130°. Most preferably, the upper gearing angle α is 100°, and the lower gearing angle β is 124°. By having upper and lower gearing angles α, β with these values, the gearbox 4 is more compact and better adapted to the layout requirements of the ATV 100.

The preferred embodiment uses the rear output gear 431 as the ring gear of a rear differential 45 within the gearbox housing 42, effectively reducing the space occupied by the rear differential 45 and making the layout more compact. The front delivery shaft 416 has a bevel gear 432 on its rear end to receive torque from the front output shaft 415, and has a splined outer profile 4161 on its front end to transmit torque to a front drive shaft (not shown). The front drive shaft transmits torque to the front wheels 251 through a front differential (not shown).

The meshing of the gear assembly 43 generates substantial friction with the resultant generation of heat. The rotating shafts 41 also generate friction in their bearings (4111, 4134 and other bearings not separately called out). To reduce the friction drag, it is necessary to timely lubricate the gear assembly 43 and the shafts 41. The gearbox housing 42 is provided with lubricating fluid such as grease or more preferably gearbox oil, and the gearbox oil is distributed on the gear assembly 43 and each of the shafts 41 through splash lubrication, that is, the gearbox oil is driven by the gear assembly 43 and splashed to various positions, thereby lubricating various components. In order to better perform splash lubrication, the countershaft 413 is a hollow structure as shown in FIG. 11, forming a cavity 4131. One end of the countershaft 413 is provided with an end opening 4132 to the cavity 4131, and the end opening 4132 can collect the gearbox oil in a falling process. Oil passing holes 4133 are distributed both circumferentially and axially on the countershaft 413, the oil passing holes 4133 can throw gearbox oil out of the cavity 4131 during the high-speed rotation of the countershaft 413 on the gear assembly 43 and/or the input shaft 411 and the front output shaft 415. For best gearbox oil capture and throw out of the countershaft cavity 4131, the diameter of the oil passing holes 4133 is preferably greater than or equal to 2 mm and less than or equal to 4 mm, more preferably greater than or equal to 2.5 mm and less than or equal to 3.5 mm, and most preferably 3 mm.

To further enhance lubrication, an oilguide baffle 421 (shown in FIGS. 7 and 11) extends inwardly relative to a side wall 422 of the gearbox housing 42 at least partially toward the end opening 4132 of the countershaft 413. The oilguide baffle 421 guides gearbox oil in a splashing and falling process to the end opening 4132 of the countershaft 413, thereby further increasing the amount of oilflow through the countershaft cavity 4131 and enhancing the splash lubrication effect. When viewed from a direction perpendicular to the axis of the countershaft 413, the oilguide baffle 421 and the countershaft 413 at least partially overlap, so as to ensure that gearbox oil collected by the oilguide baffle 421 can effectively flow into the countershaft cavity 4131. The oilguide baffle 421 preferably includes a collecting portion 4211 and a flow guiding portion 4212. The collecting portion 4211 is preferably annular, arranged coaxially relative to the countershaft 413. The flow guiding portion 4212 is contiguous with the collecting portion 4211, arranged obliquely relative to the countershaft 413. The preferred arrangement of the collecting portion 4211 and the flow guiding portion 4212 allows gearbox oil to be quickly collected and directed to quickly flow into the countershaft cavity 4131 through the end opening 4132.

For assembly purposes, the preferred gearbox housing 42 includes an input shaft cover 423 and a front output shaft cover 424, both attached with bolts 425. The input shaft cover 423 is shown in exploded view in FIGS. 6 and 7, and FIG. 8 shows the gearbox housing 42 with both the input shaft cover 423 and the front output shaft cover 424 removed. The input shaft cover 423 in the preferred embodiment has a countershaft cover portion 4231 which covers an end of the countershaft 413. The oilguide baffle 421 is most preferably provided as part of the countershaft cover portion 4231 as shown in FIG. 7. The front output shaft cover 424 in the preferred embodiment similarly has an intermediate cover portion 4241 (called out in FIGS. 5 and 6) which covers an end of the intermediate shaft 414.

As called out in FIG. 6, the input shaft 411 is supported on the gearbox housing 42 through an input shaft bearing 4111 mounted in a bearing-receiving recess 4221 on the side wall 422 of the gearbox housing 42. As shown in FIG. 9, at least some of the gears 433 on the input shaft 411 are preferably helical gears rather than straight cut. The input shaft bearing 4111 needs to support the axial loads provided by helical gears 433, which axial loads vary as a function of rotational speed. Due to the varying axial loads, the input shaft bearing 4111 can easily become loosened in an axial direction. The input shaft cover 423 closes at least part of the bearing-receiving recess 4221. As shown in FIG. 7, the inside face 4232 of the input shaft cover 423 is not flat, but instead includes a bearing abutment lip 4233. The bearing abutment lip 4233 extends from the plane of the inside face 4232, in a direction basically parallel to the input shaft 411, at least partially into the bearing-receiving recess 4221. The preferred bearing abutment lip 4233 circumferentially encircles the input shaft 411. When the input shaft cover 423 is fixed to the gearbox housing 42 via bolts 425, the bearing abutment lip 4233 provides an axial, inwardly-directed force on the input shaft bearing 4111 to prevent axial loosening of the input shaft bearing 4111 in the bearing-receiving recess 4221, without the need for additional limiting members.

The countershaft 413 is installed on the gearbox housing 42 through countershaft bearings 4134 called out in FIG. 11. A nut 4135 (called out in FIG. 10) cooperates with a threaded portion of the countershaft 413 adjacent the gearbox housing 42 to axially compress the countershaft bearings 4134, preventing the countershaft 413 from moving on the countershaft bearings 4134. It can be understood that the reverse shaft 412, the intermediate shaft 414 and the rear output gear 431 are similarly installed on the gearbox housing 42 through bearings (either not called out or not shown) compressed by nuts (either not called out or not shown). With each of the shafts 41 prevented from moving axially on its respective bearings (4111, 4134, other bearings not called out), sufficient and stable meshing of the gear assembly 43 is ensured, and the stability of torque transmission is improved.

The gearbox housing 42 further includes a front delivery shaft sleeve 426. The front delivery shaft sleeve 426 extends longitudinally and surrounds and supports at least part of the front delivery shaft 416. The front delivery shaft sleeve 426 improves the convenience and reliability of the bevel gear connection between the front delivery shaft 416 and the front output shaft 415. As best shown in FIG. 3, the front delivery shaft sleeve 426 is preferably arranged between the crankcase 15 and the inner housing 31 of the CVT 3, passing under the crankshaft 11. To provide adequate support for the front delivery shaft 416 as part of the prime mover assembly 10, a front delivery shaft sleeve length L2 (called out in FIG. 7) of the front delivery shaft sleeve 426 is preferably greater than or equal to 220 mm and less than or equal to 300 mm, more preferably greater than or equal to 240 mm and less than or equal to 280 mm, and most preferably greater than or equal to 260 mm and less than or equal to 270 mm. By having a front delivery shaft sleeve length L2 within these preferred ranges, the front delivery shaft 416 can have its splined output end 4161 located at the front of the prime mover assembly 10 for easy connection to the front drive shaft (not shown), even with the tall and narrow gearbox 4 discussed above.

The front delivery shaft sleeve 426 preferably includes a vertically extending sleeve mounting flange 4261. In the preferred embodiment, the sleeve mounting flange 4261 has two types of bolt holes 4262, 4263, with both types extending transversely, namely, the sleeve mounting flange 4261 has transversely directed throughholes 4262 used to bolt the front delivery shaft sleeve 426 to the crankcase 15 and transversely directed threaded holes 4263 used to bolt the CVT inner housing 31 to the front delivery shaft sleeve 426. The transversely directed throughholes 4262 allow the front delivery shaft sleeve 426 to be fixed relative to the engine 1 from a direction perpendicular to the front delivery shaft 416. The transversely directed threaded holes 4263 allow the CVT inner housing 31 to be bolted on at locations where the engine 1 does not adequately extend. Alternatively to being threaded, the second type of transversely extending hole 4263 may allow bolts 4264 (FIG. 3) to be used which attach both the CVT inner housing 31 and the front delivery shaft sleeve 426 to the crankcase 15. The front delivery shaft sleeve 426 also includes longitudinally directed mounting holes 4265, for bolts 4266 extending generally parallel to the axis of the front delivery shaft 416. The longitudinally directed mounting holes 4265 are used to bolt the front delivery shaft sleeve 426 to the rest of the gearbox housing 42. By having the bolts 4264, 4266 which attach the front delivery shaft sleeve 426 extend in two different directions, the attachment of the front deliver shaft sleeve 426 is made more secure.

The front delivery shaft sleeve 426 defines a cavity (not separately called out) which accommodates the front delivery shaft 416, which cavity is in communication with the space enclosed by the rest of the gearbox housing 42, such that the continuity of lubrication between the front delivery shaft 416 and the front output shaft 415 can be ensured. The front end 4267 of the front delivery shaft sleeve 426 is provided with an oil seal 4268 as called out in FIGS. 6-8. After the front delivery shaft 416 is connected to the front delivery shaft sleeve 426, the oil seal 4268 seals between the front delivery shaft 416 and the front delivery shaft sleeve 426, so as to prevent the gearbox oil inside the cavity of the front delivery shaft sleeve 426 from leaking.

The front delivery shaft 416 and the front output shaft 415 are in meshed connection through the bevel gear 432 to transmit torque. In some embodiments, the bevel gear 432 is in a relatively independent space within the gearbox housing 42 relative to the rest of the meshed gear connections. The bevel gear 432 has a high requirement for lubrication, and arranging the bevel gear 432 in a relatively independent lubrication space helps ensure full lubrication, thereby ensuring the stability of power transmission.

At the same time, by arranging the front delivery shaft sleeve 426 to be detachably connected to the gearbox housing 42, the convenience of installation between the front delivery shaft 416 and the gearbox 4 can be improved. Specifically, the front delivery shaft sleeve 426 is an independent part, and the front delivery shaft 416 can inserted into the front delivery shaft sleeve 426 first, prior to bolting the front delivery shaft sleeve 426 to the rest of the gearbox housing 42 and the crankcase 15. After assembly of the front delivery shaft 416 into the front delivery shaft sleeve 426, the assembly 426/416 is connected to the gearbox housing 42, thereby greatly improving the convenience of installing the front delivery shaft 416.

As best shown in FIG. 2, the air intake system 7 preferably includes a supercharger 71, which uses exhaust gas to pressurize incoming combustion air. The air intake system 7 preferably also includes an intercooler 72, to cool air compressed by the supercharger 71 prior to introduction of the cooled, pressurized air through the valves 171 into the cylinders 141. The supercharger 71 preferably makes the full speed air consumption of the engine 1 to be greater than or equal to 650 kg/h and less than or equal to 750 kg/h, and most preferably about 726 kg/h. At such full speed air consumption, fuel consumption of the engine 1 reaches 70 kg/h, the rotational speed of the crankshaft 11 of the engine 1 is greater than or equal to 8000 r/min and less than or equal to 9000 r/min, and the power per liter of the engine 1 is greater than or equal to 150 kW/L and less than or equal to 160 kW/L. The engine 1 thus outputs a strong driving force, and the ATV 100 equipped with the engine 1 is powerful and is able to adapt to complex road conditions.

The gearbox 4 further includes a gear shifter 46 best shown in FIG. 9. The gear shifter 46 includes a shifting drum 461 on a shifting shaft 462, rotated by a shifting actuator 463. The shifting drum 461 is provided with a contour 4611, and the contour 4611 cooperates with one or more shifting forks 464 to change the axial position of gears 433 on the countershaft 413 to realize gear shifting.

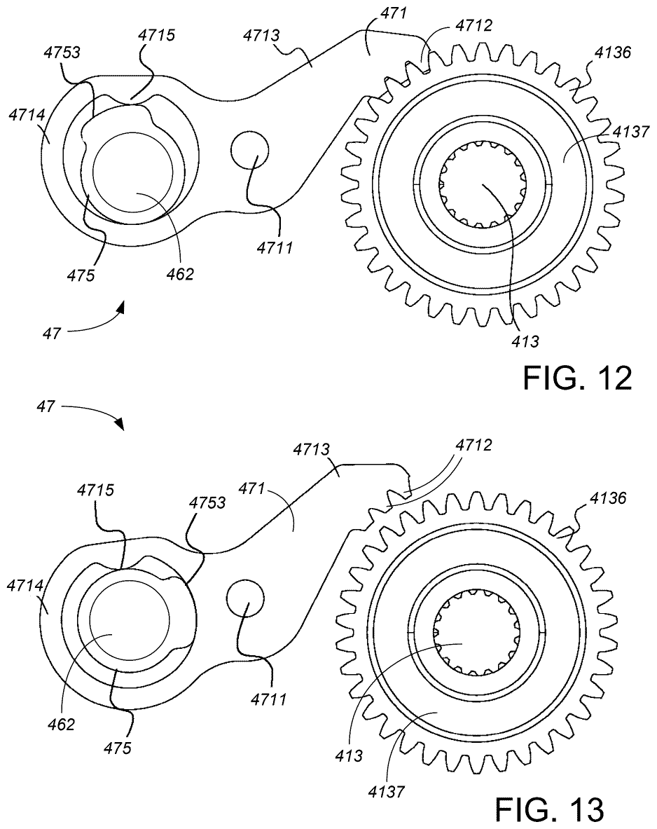

The gearbox 4 is further provided with park device 47 which includes a parking pawl 471 pivotally mounted on a parking pawl shaft 4711, shown in perspective view in FIG. 9 and in side view in FIGS. 12 and 13. The parking pawl 471 has parking pawl teeth 4712 on the end of a pawl arm 4713. When the ATV 100 is in park, the parking pawl teeth 4712 mesh into parking gear teeth 4136 of a parking gear 4137 secured on the countershaft 413 to prohibit rotation of the countershaft 413. The parking pawl 471 is biased (such as by a parking pawl torsion spring, not shown) to a non-engaged position shown in FIG. 13, where the parking pawl teeth 4712 have been moved out of meshing with the parking gear teeth 4136. The parking pawl 471 can therefore be thought of as normally not-engaged, allowing the parking gear 4137 and its countershaft 413 as well as the rest of the gear assembly 43 to rotate.

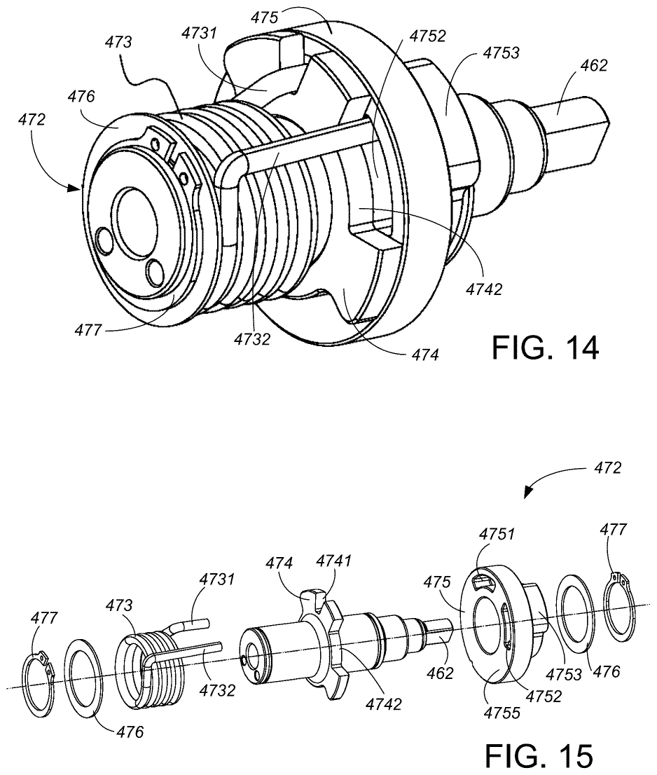

The parking pawl 471 has a pawl ring 4714 which encircles the shifting shaft 462, with a pawl ring lobe 4715 inwardly directed on the pawl ring 4714 relative to the shifting shaft 462. The park device 47 includes a parking pawl control linkage 472 between the shifting shaft 462 and the parking pawl 471. As best shown in FIGS. 9 and 14-16, the parking pawl control linkage 472 includes a parking torsion spring 473, a torsion spring transfer disc 474 and a pawl control wheel 475. The parking torsion spring 473 is rotationally mounted about the shifting shaft 462 (i.e., loosely sleeved, with no rotational force transmitted between the shifting shaft 462 and the parking torsion spring 473) and includes a first force arm 4731 and a second force arm 4732. The torsion spring transfer disc 474 is fixed relative to the shifting shaft 462, i.e., the circumferential position of the torsion spring transfer disc 474 matches the circumferential position of the shifting shaft 462 (and the circumferential position of the shifting drum 461, shown in FIG. 9). The pawl control wheel 475 is rotationally mounted on the shifting shaft 462, (i.e., loosely sleeved, with no rotational force transmitted between the shifting shaft 462 and the pawl control wheel 475. Once assembled and as best shown in reference to FIGS. 14 and 15, the first force arm 4731 of the parking torsion spring 473 extends through a first notch 4741 on the torsion spring transfer disc 474 and into a first circumferential recess 4751 on the pawl control wheel 475, while the second force arm 4732 extends through a second notch 4742 on the torsion spring transfer disc 474 and into a second circumferential recess 4752 on the pawl control wheel 475. Alternative embodiments have notches on both the torsion spring transfer disc and the pawl control wheel, have circumferential recesses on both the torsion spring transfer disc and the pawl control wheel, or have circumferential recesses on the torsion spring transfer disc and notched on the pawl control wheel. The pawl control wheel 475 includes a park lobe 4753, extending outwardly within the pawl ring 4714 as shown in FIGS. 12 and 13.

The circumferential position of the shifting shaft 462, and thus the circumferential position of the torsion spring transfer disc 474, determines when and whether a force is placed on the first and second force arms 4731, 4732 of the parking torsion spring 473. When more force is placed on one of the two force arms 4731, 4732 than the other, the parking torsion spring 473 will rotate/pivot around the shifting shaft 462 until at least one of the first and second force arms 4731, 4732 contacts the end of its circumferential recess 4751, 4752 of the pawl control wheel 475, at which point the pawl control wheel 475 will rotate/pivot around the shifting shaft 462. The pawl control wheel 475 will freely rotate/pivot around the shifting shaft 462 until the park lobe 4753 of the pawl control wheel 475 is in a circumferential position to contact/abut and begin pressing on the pawl ring lobe 4715. At this point due to increasing interference between the park lobe 4753 and the pawl ring lobe 4715, further circumferential movement of the pawl control wheel 475 will overcome the normally not-engaged spring force on the parking pawl 471, pushing the parking pawl teeth 4712 toward meshing engagement with the parking gear teeth 4136.

Sometimes, while attempting engagement between the parking pawl teeth 4712 and the parking gear teeth 4136, the parking gear 4137 will be in a circumferential position that prevents meshing. The interference between the parking pawl teeth 4712 and the parking gear teeth 4136 will prevent further pivoting of the parking pawl 471, stopping the pawl control wheel 475 from further (clockwise in FIGS. 12 and 13) rotation, but storing circumferential energy in the parking torsion spring 473 tending to bias the pawl control wheel 475 in that (clockwise) direction. The parking torsion spring 473 will then continue to bias the parking pawl control linkage 472 until the circumferential position of the countershaft 413 (and parking gear 4137) changes so the parking gear teeth 4136 line up between the parking pawl teeth 4712. Once in meshing alignment, the force between the two force arms 4731, 4732 of the parking torsion spring 473 will rotate the pawl control wheel 475 further, causing the park lobe 4753 to position itself in full interference position under the pawl ring lobe 4715 as shown in FIG. 12, thus causing the parking pawl 471 to enter the engaged position shown in FIG. 12.

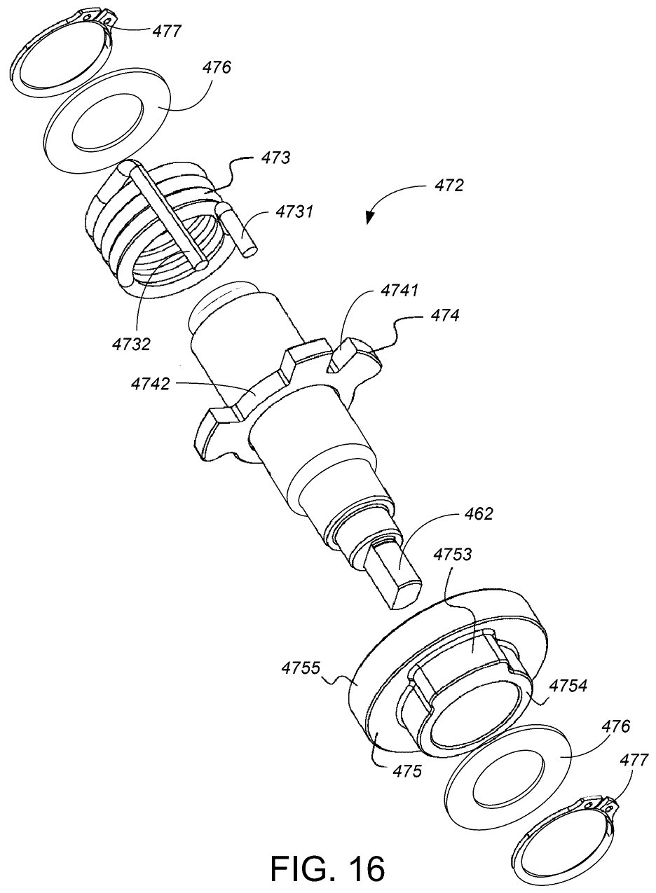

As best shown in FIG. 16, the preferred pawl control wheel 475 is formed as a stepped structure including a small cylindrical section 4754 and a large cylindrical section 4755, placing the park lobe 4753 on the small cylindrical section 4754. The pawl control wheel 475 is preferably sleeved on an opposite side of the torsion spring transfer disc 474 as the parking torsion spring 473. Both the pawl control wheel 475 and the parking torsion spring 473 can be axially held on the shifting shaft 462 using an attachment disc 476 and a retaining ring 477. The relative circumferential lengths of the first and second circumferential recesses 4751, 4752 on the pawl control wheel 475, together with the relative circumferential lengths of the first and second notches 4741, 4742 on the torsion spring transfer disc 474, in combination with the spring constant of the parking torsion spring 473, determine how the force biasing the parking pawl 471 toward the engaged position (clockwise about the parking pawl shaft 4711) changes as a function of circumferential position of the shifting shaft 462. In the preferred embodiment, the first notch 4741 on the torsion spring transfer disc 474 permits no relative motion between the first force arm 4731 and the torsion spring transfer disc 474, the first circumferential recess 4751 permits about 45° of relative motion between the first force arm 4731 and the pawl control wheel 475, the second notch 4742 on the torsion spring transfer disc 474 permits about 45° of relative motion between the second force arm 4732 and the torsion spring transfer disc 474, and the second circumferential recess 4752 permits an additional about 45° of relative motion between the first force arm 4731 and the pawl control wheel 475. Other embodiments use other relative circumferential lengths to generate the best force profile for biasing the parking pawl 471 toward the engaged position as a function of circumferential position of the shifting shaft 462. The preferred parking pawl control linkage 472 is simple and low in cost, and allows the ATV transmission to be engaged in park gear smoothly while preventing gear teeth grinding.

The shifting actuator 463 of the preferred gearbox 4, shown in FIG. 9, is electronically driven. Alternative embodiments use a cable drive to rotate the shifting shaft 462.

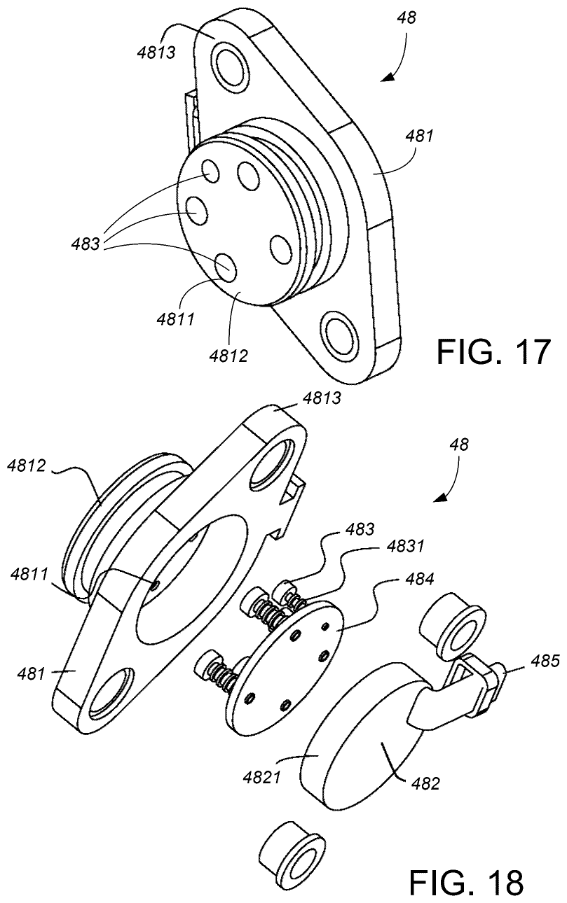

The preferred gearbox 4 is further provided with an electronic gear position sensor 48 individually shown in FIGS. 17 and 18. The electronic gear position sensor 48 is used to sense and verify the circumferential position of a contact (not shown) on the distal end of the shifting shaft 462 and/or shifting drum 461. The gear position sensor 48 is preferably installed on the gearbox 4 through the gearbox housing 42 at an opposite end of the shifting shaft 462 as the electronic actuator 463. The preferred gear position sensor 48 includes an inwardly positioned mounting flange portion 481, an outwardly positioned sealing cap 482, a plurality of contacts 483 (one for each “park”, “neutral”, “reverse”, “forward” etc. gear desired to be sensed) mounted on a soldering board 484, and cabling 485 which includes a separate wire 486 (called out only on FIGS. 3 and 10) for each contact 483. Each contact 483 extends through a hole 4811 in a cylindrical insertion portion 4812 of the mounting flange portion 481. The contacts 483 are formed of an electrically conductive material such as metal, while the mounting flange portion 481, the sealing cap 482 and the soldering board 484 are formed of a dielectric material such as being injection molded from plastic. Each of the wires 486 within the cabling 485 is soldered to a corresponding contact 483 on the outer side of the soldering board 484. The mounting flange portion 481 preferably includes two mounting ears 4813, for a bolted connection to the gearbox housing 42 so the cylindrical insertion portion 4812 extends through the gearbox housing 42. When installed, the contacts 483 extend through the mounting flange portion 481 to be exposed inside the gearbox housing 42, to make sliding contact continuity depending upon the circumferential position of the shifting shaft 462 and/or shifting drum 461. The individual wires 486 in the cabling 485 electrically connect each contact 483 with a vehicle controller (not shown).

Each contact 483 is shaped (such as being columnar or cylindrical) to close its connecting hole 4811 to prevent gearbox oil from leaking out through the connecting hole 4811. Each contact 483 also has a protruding portion 4831 with a labyrinth-shaped cross-section. The labyrinth-shaped cross-section of the protruding portions 4831 allow electrical continuity with the contact 483, while simultaneously increasing the flow path of any gearbox oil leaking between a contact 483 and its connecting hole 4811.

The sealing cap 482 is provided with a cap periphery 4821 that mates into the mounting flange portion 481. The connection between the sealing cap 482 and the mounting flange portion 481 can be detachable, but still is tight enough to avoid any gearbox oil leakage.

Traditional gear position sensors cover the soldered connection between the individual wires in the cabling and the contacts with epoxy. However, the traditional soldering is likely to cause gaps at the soldered joints due to high temperature of soldering, resulting in a higher likelihood of gearbox oil leakage through the traditional gear position sensor. By using a soldering board 484 and enclosing each of the soldered connections between the connection flange portion 481 and the sealing cap 482, the epoxy covering can be omitted and gaps caused by local overheating during soldering can be avoided.

The lubrication system 6 for the engine 1 is best shown in FIGS. 19 and 20, noting that FIG. 20 shows several internal channels looking like straight pipes (rather than their actual structures) so as to better visualize the lubricant flowpath. The lubrication system 6 circulates lubricating fluid such as engine oil to reduce wear and friction of the engine 1. An oil reservoir 161 (called out in FIGS. 4 and 20) is formed after the crankcase 15 and the oil pan 16 are connected. The lubrication system 6 pulls oil from the oil reservoir 161 and delivers and/or sprays oil to moving parts/wear surfaces of the engine 1 to reduce wear. The oil also helps to cool parts of the engine 1.

The crankcase 15 includes a crankcase sidewall 151, and the oil filter 62 and the oil cooler 63 are both mounted on the crankcase sidewall 151. The oil pump 61 pulls oil from the reservoir 161 through an oil pipe 641 and a return sidewall oil passage 642, and then pushes oil through the oil filter 62 and oil cooler 63 at least partially using a supply sidewall oil passage 643. By using the sidewall oil passages 642, 643, structural space within the crankcase 151 is fully utilized and the arrangement of pipelines is minimized, saving cost and space.

The preferred engine 1 includes a balance shaft 175 (shown and called out only in FIG. 4) in conjunction with the crankshaft 11, to balance rotational forces and reduce vibration of the engine 1. The preferred crankcase 15 has a main oil passage 644 in communication with the supply sidewall oil passage 643. The crankcase 15 is provided with at least one balance shaft bearing seat 1751 and at least one crankshaft bearing seat 111. Both ends of the balance shaft 175 are rotatably connected to the crankcase 15 through balance shaft bearings (not separately shown) arranged in the balance shaft bearing seat(s) 1751, and the crankshaft 11 is rotatably connected to the crankcase 15 through crankshaft bearings (not separately shown) arranged in each of the crankshaft bearing seats 111. The crankcase 15 is further provided with at least one crankshaft oil passage 645 receiving oil from the main oil passage 644 and delivering oil to the crankshaft bearing seat(s) 111 to lubricate the crankshaft bearings. The crankcase 15 is further provided with a balance shaft oil passage 646 receiving oil from the main oil passage 644 and delivering oil to the balance shaft bearing seat(s) 1751 to lubricate the balance shaft bearings. Additionally, a balance shaft oil passage (not separately shown) is arranged inside the balance shaft 175 to deliver oil longitudinally along the balance shaft 175, increasing and balancing oil flow rate to improve lubrication and heat dissipation of the balance shaft 175.

FIG. 19 also shows the preferred location of the alternator 91, at an end of the crankshaft 11 opposite the CVT 3, between the crankshaft 11 and the crankcase sidewall 151. The alternator 91, further shown in FIG. 21 in exploded view relative to the crankshaft 11, includes a stator 911 surrounding a rotor 912. The stator 911 is preferably at least partially surrounded by the crankcase sidewall 151 and fixedly connected to the crankcase sidewall 151. The rotor 912 is preferably fixedly connected to the crankshaft 11 for rotation with the crankshaft 11. While the connection between the rotor 912 and the crankshaft 11 could be by pressfitting, more preferably the rotor 912 and the crankshaft 11 are connected by a key (not shown) on the crankshaft 11 coupled into a keyway 9121 on an inside diameter 9123 of the rotor 912. When the engine 1 is working, the crankshaft 11 drives the rotor 912 to rotate relative to the stator 911 to cut magnetic induction lines for power generation. In the preferred embodiment, the rated power of the alternator 91 is greater than or equal to 0.9 kW and less than or equal to 1.5 kW. The alternator 91 can generate considerable heat when outputting such a large amount of electricity. In order to keep the alternator 91 within a temperature range of less than or equal to 220° C., the alternator 91 is cooled, preferably using engine oil.

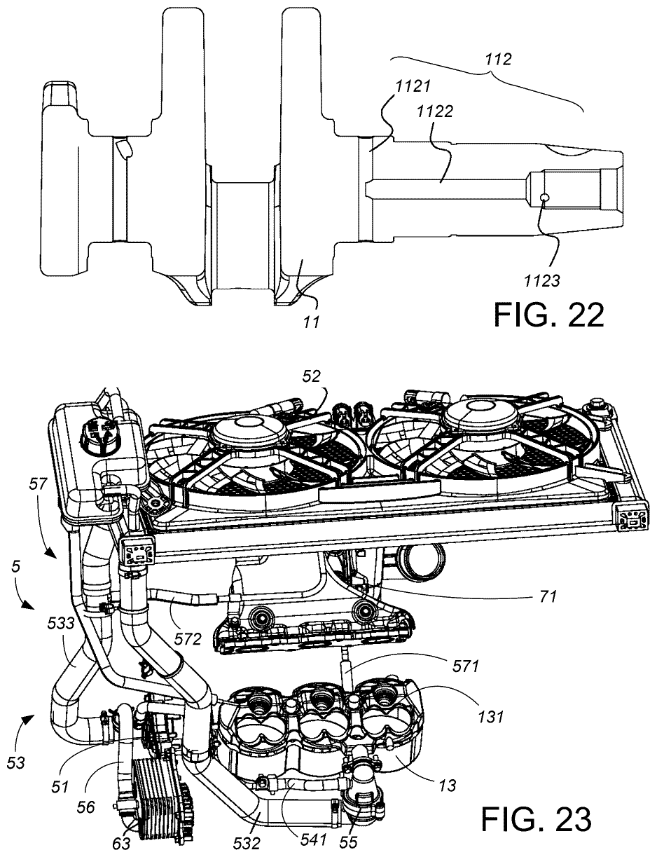

Specifically, the crankshaft 11 includes an interior crankshaft oil passage 112 best shown in FIG. 22, but also shown in FIG. 20 with internal channels looking like straight pipes. The interior crankshaft oil passage 112 includes one or more (most preferably two) radial inflow segments 1121, a longitudinal segment 1122 in fluid communication with the radial inflow segment(s) 1121, and one or more (most preferably two) radial outflow segments 1123 in fluid communication with the longitudinal segment 1122. The radial inflow segment(s) 1121 are in fluid communication with the main oil passage 644 through at least one of the crankshaft oil passages 645 and crankshaft bearing seats 111. The rotor 912 is at least partially penetrated by one or more rotor oil passage(s) 9122, which is (are) in fluid communication with the radial outflow segment(s) 1123. When the rotor 912 rotates, engine oil passes through the rotor 912 via the rotor oil passage(s) 9122 and can be splashed to the stator 911. This engine oil cooling arrangement can prevent the stator 911 from being ablated and damaged due to excessive temperature, and improve the safety and reliability and prolong the service life of the alternator 91.

It can be understood that the amount of heat generated by the alternator 91 depends on the amount of power generated. In order to meet the cooling requirements of the high-power alternator 91, the diameter of the radial outflow segment(s) 1123 of the crankshaft oil passage 112 is preferably greater than or equal to 1 mm and less than or equal to 1.4 mm. A diameter/power ratio of the diameter of the radial outflow segment(s) 1123 to a rated power of the alternator 91 is preferably greater than or equal to 0.65 mm/kW and less than or equal to 1.56 mm/kW, more preferably greater than or equal to 0.85 mm/kW and less than or equal to 1.45 mm/kW, and most preferably greater than or equal to 0.95 mm/kW and less than or equal to 1.15 mm/kW. With a diameter/power ratio within these preferred ranges, the alternator 91 can be well lubricated and cooled, maintaining its temperature to be less than or equal to 220° C. At the same time, excessive outflow of oil is avoided, which would otherwise take too great a percentage of oil from the main oil passage 644 and adversely affect the lubrication effect of other components. Cooling the alternator 91 with engine oil also allows the alternator 91 to be kept in a small package, tight in relative to the prime mover assembly 10, so less space is required for the prime mover assembly 10 including the alternator 91.

As an optional and preferred embodiment, two rotor oil passages 9122 are provided, each extending radially through the rotor 912 to the stator 911, and each spaced 120° circumferentially about the rotation axis of the rotor 912 from each other and spaced 120° circumferentially around the inner diameter 9123 from the keyway 9121. The equal circumferential spacing of the rotor oil passages 9122 and the keyway 9121 helps make the local loads borne by the crankshaft 11 and the rotor 912 more uniform, ensuring the structural strength of the crankshaft 11 and the rotor 912. The radius of each of the two rotor oil passages 9122 is preferably greater than or equal to 2 mm and less than or equal to 4 mm, more preferably greater than or equal to 2.5 mm and less than or equal to 3.5 mm. Rotor oil passages 9122 within the preferred size range can not only meet the heat dissipation and lubrication requirements of the alternator 91, but also ensure the structural strength of the crankshaft 11 and the rotor 912.

A preferred embodiment of the cooling system 5 is best shown in FIGS. 23-25. The cooling system 5 circulates coolant through the engine 1 to take away the heat generated by the engine 1 during operation. The cooling system 5 includes a pump 51 (referred to as a “water pump”, even though the coolant may be antifreeze or the like rather than water) and a radiator 52. The water pump 51 pushes coolant to the engine 1 through a main coolant loop 53 having a pressure line 531, with hot coolant moving from the engine 1 to the radiator 52 through a main supply line 532, and with the water pump 51 drawing cooled coolant from the radiator 52 through a main return line 533.

The cooling requirement of the cooling system 5 (i.e., amount of heat which needs to be extracted from the engine 1) depends upon how hard the engine 1 is working and upon the external air temperature. The preferred cooling system 5 also includes a direct circulation loop 54 which bypasses the radiator 52 and includes a direct return line 541. The cooling system 5 includes a temperature sensor (not shown) and a thermostat valve 55, with the thermostat valve 55 arranged in the main coolant supply line 532 adjacent the engine 1. The temperature sensor is configured to monitor the temperature of the coolant and provide an electrical signal indicative of coolant temperature to the thermostat valve 55. When the coolant temperature is sensed to be lower than a preset threshold temperature, the thermostat valve 55 directs coolant coming out of the engine 1 to the direct return line 541 for its return to the water pump 51. When the coolant temperature is sensed to be higher than the preset threshold temperature, the thermostat valve 55 directs coolant coming out of the engine 1 to the main supply line 532 for travel through the radiator 52. In the preferred embodiment, the preset threshold temperature is set to 82° C. Other embodiments use a different preset threshold temperature. While the preferred thermostat valve 55 operates electronically, alternative embodiments utilize an entirely mechanical valve similar to a radiator cap valve (not shown).

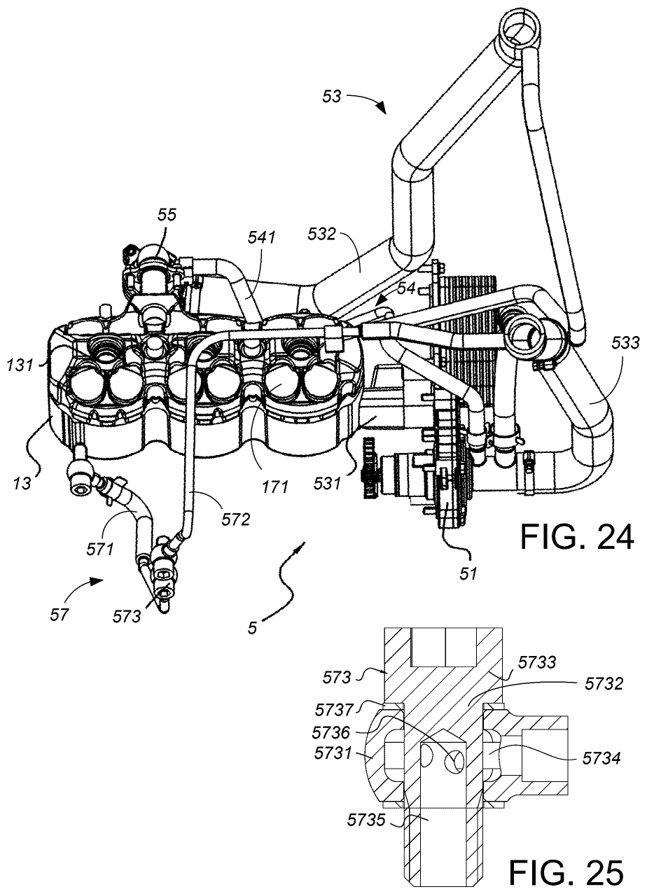

The preferred cooling system 5 directs coolant from the pressure line 531 to an engine block water jacket 142 (called out only in FIG. 4) and to a cylinder head water jacket 131 (called out in FIGS. 23 and 24), both of which are in fluid communication with the thermostat valve 55. The engine block water jacket 142 is arranged around the combustion chambers 141. The cylinder head water jacket 131 is arranged around the valves 171 at the top of the combustion chambers 141.

If desired, the oil cooler 63 could be air cooled. More preferably and as shown in FIGS. 23 and 24, the preferred cooling system 5 also directs coolant from the pressure line 531 to the oil cooler 63, with coolant returning from the oil cooler 63 to the water pump 51 directly through an oil cooler return line 56 (which does not go through the thermostat valve 55). An alternative embodiment pipes coolant coming out of the oil cooler 63 first to the thermostat valve 55, so the thermostat valve 55 can control whether coolant coming from the oil cooler 63 bypasses the radiator 52 on its way back to the water pump 51.

The preferred cooling system 5 also includes a separate supercharger loop 57 in communication with the supercharger 71. The supercharger loop 57 includes a supercharger supply line 571 coming out of the cylinder block water jacket 142 with coolant flowing to the supercharger 71, and a supercharger return line 572 coming out of the supercharger 71 with coolant flowing to the main return line 533. The supercharger return line 572 preferably includes an elevation difference, with coolant flowing upwardly, before it reaches the main return line 533 at the top end of both the supercharger return line 572 and the main return line 533.

Due to the high temperature of exhaust gas when exiting the engine 1, the supercharger 71 runs quite hot. When the engine 1 is turned off and the water pump 51 is no longer driven and pumping, the supercharger 71 may be at a temperature which exceeds the vaporization temperature of the coolant. Coolant, no longer being pumped, can absorb more heat from the supercharger 71 and vaporize within the supercharger 71 after running of the engine 1 stops. Vaporization bubbles of coolant will form within the supercharger 71, which, being lighter than liquid coolant, will flow upwardly in the supercharger return line 572. With a correctly sized supercharger return line 572, the vaporization bubbles with push coolant in front of them, upwardly to the top of the coolant column in the main return line 533, while drawing a vacuum behind them. The coolant will then attempt to equalize in pressure by flowing downwardly in the main return line 533, through the (inactive) water pump 51 and pressure line 531, through the engine block water jacket 142 and back through the supercharger supply line 571 to the supercharger 71. That is, with a correctly sized and correct elevation difference on the supercharger return line 572, excess heat in the supercharger 71 will still cause coolant circulation through the engine block water jacket 142 and through the supercharger 71 even after the engine 1 and water pump 51 are no longer running. The supercharger return line 572 is thus arranged to help remove excessive heat from both the engine 1 and the supercharger 71 after the engine 1 is shut off, preventing the likelihood of damage due to such residual heat. Continuing cooling of the engine 1 after engine shutdown is ensured due to the supercharger return line 572, and heat dissipation cost is reduced, keeping the overall structure of the engine 1 more compact while meeting the requirements of heat dissipation.

The supercharger loop 57 includes a supercharger coolant control connector 573 positioned in either the supercharger supply line 571 or the supercharger return line 572 adjacent the supercharger 71 as shown in FIG. 24, with the supercharger coolant control connector 573 better shown in FIG. 25. The supercharger coolant control connector 573 includes an internally threaded fitting 5731 and an externally threaded fitting 5732. The externally threaded fitting 5732 is threaded into the internally threaded fitting 5731, and includes a head 5733 such as for a screwdriver or allen wrench used for rotating the externally threaded fitting 5732 relative to the internally threaded fitting 5731. Both the internally threaded fitting 5731 and the externally threaded fitting 5732 have central channels 5734, 5735. When threadingly advanced into the internally threaded fitting 5731, the central channel 5735 of the externally threaded fitting 5732 at least partially intersects with the central channel 5734 of the internally threaded fitting 5731. The internally threaded fitting 5731 is provided with one or more coolant regulation through holes 5736, and the central channel 5735 of the externally threaded fitting 5732 is in fluid communication with the central channel 5734 of the internally threaded fitting 5731 via the coolant regulation through holes 5736. By controlling how far the externally threaded fitting 5732 is rotationally advanced into the internally threaded fitting 5731, how much of the radius of the coolant regulation through hole(s) 5736 is(are) exposed can be controlled, so the flow rate of coolant in the supercharger loop 57 can be at least partially controlled. A gasket 5737 is arranged between the internally threaded fitting 5731 and the externally threaded fitting 5732 to prevent the leakage of the coolant. In a preferred embodiment, the gasket 5737 is formed out of a soft metal such as copper to improve the reliability of the gasket 5737 across wide temperatures.

It should be understood that for those skilled in the art, improvements or modifications can be made based on the above description, and all such improvements and modifications shall fall within the protection scope of the appended claims of the present invention.

1. An all-terrain vehicle, comprising:
a frame;
a body cover at least partially arranged on the frame;
four wheels supporting the frame;
a prime mover assembly supported on the frame and configured to drive the wheels to rotate for locomotion of the all-terrain vehicle;
a gearbox at least partially arranged on the prime mover assembly and configured to output torque of the prime mover assembly, the gearbox having a gearbox housing, the gearbox comprising:
a collection of shafts supported within the gearbox housing for rotation about axes which extend generally horizontally and transverse relative to the frame of the all-terrain vehicle, the collection of shafts including at least an input shaft, a reverse shaft and a front output shaft, the input shaft being elevationally highest in the collection of shafts, the front output shaft being elevationally lowest in the collection of shafts such that a vertical shaft spacing distance is defined between an axis of the input shaft and an axis of the front output shaft, the reverse shaft being forwardmost in the collection of shafts;
a rear output gear supported within the gearbox housing for rotation about a rear output gear axis which extends generally horizontally and transverse relative to the frame of the all-terrain vehicle, the rear output gear axis being further rearward than the axis of the input shaft and further rearward than the axis of the front output shaft, with a horizontal shaft spacing distance being defined between an axis of the reverse shaft and the rear output gear axis;
a shifting drum on a shifting shaft within the gearbox housing, the shifting drum having at least one shifting contour on its periphery;
a shifting actuator which can be controlled to drive the shifting shaft to rotate, and the shifting shaft drives the shifting drum to rotate to realize gear shifting of at least one gear on the collection of shafts via the shifting contour;
a parking gear supported on one of the collection of shafts within the gearbox housing;
a parking pawl supported within the gearbox housing, such that the parking pawl has a disengaged position relative to the parking gear that allows the parking gear and at least the front output shaft and the rear output gear to rotate, and such that the parking pawl has an engaged position relative to the parking gear that prevents the parking gear and at least the front output shaft and the rear output gear from rotating;
wherein a shaft spacing aspect ratio of the vertical shaft spacing distance to the horizontal shaft spacing distance is greater than or equal to 0.85 and less than or equal to 1.4.

2. The all-terrain vehicle according to claim 1, wherein the parking pawl is moved using a parking pawl control linkage, the parking pawl control linkage comprising a pawl control wheel rotationally mounted about an axis of the shifting shaft, the pawl control wheel having a park lobe, wherein rotation of the shifting shaft causes rotation of the pawl control wheel such that the park lobe pushes on the parking pawl to move the parking pawl from the disengaged position to the engaged position.

3. The all-terrain vehicle according to claim 2, wherein the parking pawl control linkage further comprises a torsion spring rotationally mounted about an axis of the shifting shaft, wherein rotation of the shifting shaft causes the torsion spring to circumferentially bias the pawl control wheel.

4. The all-terrain vehicle according to claim 3, wherein the torsion spring comprises first and second force arms, wherein the parking pawl control linkage comprises a torsion spring transfer disc fixed to the shifting shaft, the torsion spring transfer disc mating with the first and second force arms such that rotation of the shifting shaft and torsion spring transfer disc can change a spring force between the first and second force arms.

5. The all-terrain vehicle according to claim 2, wherein the parking pawl comprises a pawl ring encircling the axis of the shifting shaft, the pawl ring having a pawl ring lobe inwardly directed relative to the axis of the shifting shaft, wherein the park lobe of the pawl control wheel is located within the pawl ring, such that rotation of the pawl control wheel causes the park lobe to push on the pawl ring lobe causing the parking pawl to move from the disengaged position to the engaged position.

6. The all-terrain vehicle according to claim 1, wherein the vertical shaft spacing distance is greater than or equal to 170 mm and less than or equal to 230 mm, and wherein the horizontal shaft spacing distance is greater than or equal to 160 mm and less than or equal to 200 mm.

7. The all-terrain vehicle according to claim 1, wherein the collection of shafts further comprises a countershaft and an intermediate shaft, wherein an input/counter connecting line is defined between the axis of the input shaft and an axis of the counter shaft, wherein a counter/intermediate connecting line is defined between the axis of the countershaft and an axis of the intermediate shaft, wherein an intermediate/front output connecting line is defined between the axis of the intermediate shaft and the axis of the front output shaft, wherein an upper gearing angle between the input/counter connecting line and the counter/intermediate connecting line is greater than or equal to 90° and less than or equal to 110°, and wherein a lower gearing angle between the counter/intermediate connecting line and the intermediate/front output connecting line is greater than or equal to 110° and less than or equal to 130°.

8. The all-terrain vehicle according to claim 1, wherein the rear output gear is part of a rear differential provided within the gearbox housing.

9. The all-terrain vehicle according to claim 1, wherein the collection of shafts further comprises a countershaft, wherein the countershaft is hollow to define a cavity with an end opening and at least one oil passing hole extending radially through the countershaft, for lubricating oil to enter the cavity through the end opening and exit the cavity through the at least one oil passing hole.

10. The all-terrain vehicle according to claim 9, wherein the gearbox housing comprises an oilguide baffle with a flow guiding portion directing lubricating oil into the end opening of the countershaft.

11. The all-terrain vehicle according to claim 10, wherein the oilguide baffle is provided on a shaft cover bolted on as part of the gearbox housing.

12. The all-terrain vehicle according to claim 1, wherein the input shaft is support with a bearing positioned within a bearing-receiving recess of the gearbox housing, wherein the gearbox housing comprises an input shaft cover with a gearing abutment lip configured to enclose the bearing in the bearing-receiving recess with the bearing abutment lip of the input shaft cover abutting against the bearing.

13. The all-terrain vehicle according to claim 1, wherein a front delivery shaft extending longitudinally and driven by the front output shaft through a bevel gear on a rear end of the front delivery shaft, wherein the front delivery shaft is within a front delivery shaft sleeve provided as a separate part of the gearbox housing.

14. The all-terrain vehicle according to claim 1, wherein the front delivery shaft sleeve comprises a sleeve mounting flange extending longitudinally, the sleeve mounting flange having one or more bolt holes for one or more transversely extending bolts to attach the front delivery shaft sleeve relative to an internal combustion engine of the prime mover assembly, the front delivery shaft sleeve also attached with longitudinally extending bolts.

15. The all-terrain vehicle according to claim 1, wherein the prime mover assembly comprises an internal combustion engine with a rotating crankshaft, wherein the crankshaft has an interior crankshaft oil passage for oil to flow axially within the crankshaft.

16. The all-terrain vehicle according to claim 15, wherein the interior crankshaft oil passage has one or more radial outflow passages which supply oil to a rotor of an alternator.

17. The all-terrain vehicle according to claim 1, wherein the prime mover assembly comprises an internal combustion engine with an engine block having an engine block water jacket and a cooling system circulating coolant through the engine block water jacket, the cooling system comprising:
a water pump driven by the engine for pumping coolant;
a radiator for cooling of the coolant;
a main coolant loop having a main supply line running from the engine block water jacket to the radiator and a main return line running from the radiator to the water pump;
a valve in the main supply line; and
a direct return line running from the valve to the water pump, the direct return line bypassing the radiator.

18. The all-terrain vehicle according to claim 1, wherein the prime mover assembly comprises an internal combustion engine with an engine block having an engine block water jacket and a cooling system circulating coolant through the engine block water jacket, the cooling system comprising:
a water pump driven by the engine for pumping coolant;
a radiator for cooling of the coolant;
a main coolant loop having a main supply line running from the engine block water jacket to the radiator and a main return line running from the radiator to the water pump; and
a supercharger coolant loop having a supercharger supply line running from the engine block water jacket to a supercharger and a supercharger return line running and raising in elevation from the supercharger to the main return line.

19. An all-terrain vehicle, comprising:
a frame;
a body cover at least partially arranged on the frame;
four wheels supporting the frame;
a prime mover assembly supported on the frame and configured to drive the wheels to rotate for locomotion of the all-terrain vehicle;
a gearbox at least partially arranged on the prime mover assembly and configured to output torque of the prime mover assembly, the gearbox having a gearbox housing, the gearbox comprising:
a collection of shafts supported within the gearbox housing for rotation about axes which extend generally horizontally and transverse relative to the frame of the all-terrain vehicle, the collection of shafts including at least an input shaft, a reverse shaft and a front output shaft;
a shifting drum on a shifting shaft within the gearbox housing, the shifting drum having at least one shifting contour on its periphery;
a shifting actuator which can be controlled to drive the shifting shaft to rotate, and the shifting shaft drives the shifting drum to rotate to realize gear shifting of at least one gear on the collection of shafts via the shifting contour;
a parking gear supported on one of the collection of shafts within the gearbox housing;
a parking pawl supported within the gearbox housing, such that the parking pawl has a disengaged position relative to the parking gear that allows the parking gear and at least the front output shaft to rotate, and such that the parking pawl has an engaged position relative to the parking gear that prevents the parking gear and at least the front output shaft from rotating;
wherein the parking pawl is moved using a parking pawl control linkage, the parking pawl control linkage comprising a pawl control wheel rotationally mounted about an axis of the shifting shaft, the pawl control wheel having a park lobe, wherein rotation of the shifting shaft causes rotation of the pawl control wheel such that the park lobe pushes on the parking pawl to move the parking pawl from the disengaged position to the engaged position.

20. The all-terrain vehicle according to claim 19, wherein the parking pawl control linkage further comprises a torsion spring rotationally mounted about an axis of the shifting shaft, wherein rotation of the shifting shaft causes the torsion spring to circumferentially bias the pawl control wheel, wherein the torsion spring comprises first and second force arms, wherein the parking pawl control linkage comprises a torsion spring transfer disc fixed to the shifting shaft, the torsion spring transfer disc mating with the first and second force arms such that rotation of the shifting shaft and torsion spring transfer disc can change a spring force between the first and second force arms.
